(19) United States
(12) Patent Application Publication
(10) Pub. No.: US 2018/0266933 A1
(43) Pub. Date: Sep. 20, 2018

(54) SYSTEM AND METHOD FOR AIR MONITORING

(71) Applicant: WHITE LAB SAL, Beirut (LB)

(72) Inventors: Eve Tamraz, London (GB); Cyrille Najjar, London (GB)

(21) Appl. No.: 15/727,302

(22) Filed: Oct. 6, 2017

(30) Foreign Application Priority Data
Mar. 14, 2017 (GB) 1704078.3

(51) Int. Cl. G01N 15/06; G01N 15/14

(52) U.S. Cl. CPC G01N 15/06; H04Q 9/00; G01N 15/1431

(57) ABSTRACT

A sensing device includes a sensor configured to obtain a spectral signature of at least one airborne particle. The sensor control circuitry is configured to compare the spectral signature of the at least one particle in the airflow with the reference spectral signatures for the plurality of types of particles and identify a first type of particle corresponding to the at least one particle in the airflow. The sensor control circuitry may also access a database to obtain health advice associated with the identified first type of particle and provide a report to a user device.

### CROSS REFERENCE TO RELATED APPLICATIONS

The present application claims priority under 35 U.S.C. § 119(a) to U.K. Application No. 1704078.3 entitled, “A DEVICE, COMPUTER PROGRAM AND METHOD,” filed Mar. 14, 2017, and hereby expressly incorporated by reference herein.

### FIELD

This application relates to systems and methods for monitoring and identification of types of airborne particles and provision of health advice in response thereto.

### BACKGROUND

Allergic reactions to particles are debilitating and in some instances can be fatal. In order to monitor these particles, techniques exist whereby sticky tape is used to capture, in particular, airborne particles. This tape is sent to a laboratory for analysis by a technician. The technician reviews the sticky tape under a microscope and identifies the types of particles. The user then receives the results of the analysis by the technician.

This current technique has several drawbacks. First, due to the large amount of human analysis, the cost for the technique is high. The results derived from this technique can be quite poor. Second, there is the risk of contamination during the capture and transportation for analysis which may lead to false results. Third, the analysis of the sticky tape may take days, so the results only indicate the airborne particles from several days ago. This delay means that the particle information is not current and may not be used for immediate determination of a cause of allergic symptoms. In addition, allergen levels are often only analyzed and provided for a large geographical area, such as an entire city or region and is not representative of the immediate environment of the user. It would be desirable, therefore, to provide a substantially real-time and automated mechanism to detect allergens.

In addition, there is no known mechanism to prevent or warn of particulates especially indoors. Typically, an individual will only be aware of the presence of allergens or other airborne particles after the individual begins suffering symptoms. For example, the user may start sneezing or having breathing difficulties. The user will then need to medicate. It would be desirable, therefore, to be able to provide warnings of any increase in airborne particulates so that a user may take preventative action.

As such, there is a need for an air monitoring system and method that detects and identifies airborne particles and provides health advice based on the identified types of airborne particles. Furthermore, there is a need for a system that explains to the user the cause of their symptoms and warns them beforehand to take preventative actions.

### SUMMARY

According to a first aspect, a sensing device includes a storage device configured to store a database, wherein the database includes reference spectral signatures for a plurality of types of particles and health advice associated with each of the plurality of types of particles. The sensing device further includes a sensor configured to obtain a spectral signature of at least one particle in an airflow. The sensing device further includes a sensor control circuitry configured to compare the spectral signature of the at least one particle in the airflow with the reference spectral signatures for the plurality of types of particles; identify a first type of particle corresponding to the at least one particle in the airflow; and access the database to obtain health advice associated with the identified first type of particle.

According to a second aspect, a method for monitoring airborne particles includes obtaining a spectral signature of at least one particle in an airflow; comparing the spectral signature of the at least one particle in the airflow with reference spectral signatures for a plurality of types of particles; and identifying a first type of particle corresponding to the at least one particle in the airflow from the comparison. The method further includes accessing a database to obtain health advice associated with the identified first type of particle; and providing the health advice to a user device for display.

In one or more of the above aspects, communication circuitry configured to communicate over a network to a remote server and receive from the remote server the reference spectral signatures for the plurality of types of particles and the health advice associated with each of the plurality of types of particles.

In one or more of the above aspects, the sensor control circuitry is further configured to store in the database the identified first type of particle and location information identifying a geographical location of the sensing device and communicate the identified first type of particle and location information identifying a geographical location of the sensing device to the remote server.

In one or more of the above aspects, the sensor control circuitry is configured to determine a local maxima and minima points in the spectral signature of the at least one particle in the airflow and compare the local maxima and minima points in the spectral signature of the at least one particle in the airflow with local maxima and minima points in the reference spectral signatures for the plurality of types of particles.

In one or more of the above aspects, the sensor control circuitry is further configured to receive logged symptoms of a user and access the database to obtain health advice associated with the identified first type of particle and the logged symptoms of the user.

In one or more of the above aspects, the sensor control circuitry is further configured to receive a logged severity of symptoms by a user and access the database to obtain health advice associated with the identified first type of particle, the logged symptoms of the user and the logged severity of symptoms by the user.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a schematic block diagram of an embodiment of an exemplary network;

FIG. 2 illustrates a schematic block diagram of an embodiment of exemplary sensing device;

FIG. 3 illustrates a schematic block diagram of an embodiment of exemplary user equipment;

FIG. 4 illustrates a schematic block diagram of an embodiment of an exemplary server;

FIG. 5 illustrates a schematic block diagram of an embodiment of an exemplary sensor;

FIG. 6 illustrates a schematic block diagram of an embodiment of an exemplary detector;

FIG. 7A illustrates a graphical diagram of an embodiment of an example reference signature for Birch pollen;

FIG. 7B illustrates a graphical diagram of an embodiment of an example reference signature for Oak pollen;

FIG. 7C illustrates a graphical diagram of an embodiment of an example reference signature for Rye pollen;

FIG. 7D illustrates a graphical diagram of an embodiment of an example reference signature for Artemisia pollen;

FIG. 8A illustrates a schematic block diagram of an embodiment of a signature for Cladosporium spores under test;

FIG. 8B illustrates a schematic block diagram of an embodiment of a signature for Dog dander under test;

FIG. 9A illustrates a schematic block diagrams of an embodiment of a database;

FIG. 9B illustrates a schematic block diagrams of an embodiment of a database;

FIG. 9C illustrates a schematic block diagrams of an embodiment of a database;

FIG. 10 illustrates a logical flow diagram of an embodiment of a method to obtain a reference signature of a particle;

FIG. 11 illustrates a logical flow diagram of an embodiment of a method to apply to a particle under test;

FIG. 12 illustrates a logic flow diagram of an embodiment of a method for determination of a type of particle; and

FIG. 13A illustrates a schematic block diagram of an embodiment of a graphical user interface (GUI) that may be generated using the health monitoring application;

FIG. 13B illustrates a schematic block diagram of an embodiment of a another GUI that may be generated using the health monitoring application.

FIG. 14 illustrates a schematic block diagram of an example of another GUI that may be generated using the health monitoring application.

FIG. 15 illustrates a schematic block diagram of an example of another GUI that may be generated using the health monitoring application.

FIG. 16 illustrates a schematic block diagram of an example of another GUI that may be generated using the health monitoring application

FIG. 17 illustrates a schematic block diagram of an example of another GUI that may be generated using the health monitoring application.

FIG. 18 illustrates a schematic block diagram of an example of another GUI that may be generated using the health monitoring application.

FIG. 19 illustrates a logical flow diagram of an embodiment of a method for determining a concentration or density of a particle in the air at a geolocation.

FIG. 20 illustrates a logical flow diagram of an embodiment of a method for providing a current concentration of particles in the air at a geolocation.

FIG. 21 illustrates a logical flow diagram of an embodiment of a method for providing a forecast of particles levels in the air at a geolocation.

### DETAILED DESCRIPTION

The word “exemplary” or “embodiment” is used herein to mean “serving as an example, instance, or illustration.” Any implementation or aspect described herein as “exemplary” or as an “embodiment” is not necessarily to be construed as preferred or advantageous over other aspects of the disclosure. Likewise, the term “aspects” does not require that all aspects of the disclosure include the discussed feature, advantage, or mode of operation.

Embodiments will now be described in detail with reference to the accompanying drawings. In the following description, numerous specific details are set forth in order to provide a thorough understanding of the aspects described herein. It will be apparent, however, to one skilled in the art, that these and other aspects may be practiced without some or all of these specific details. In addition, well known steps in a method of a process may be omitted from flow diagrams presented herein in order not to obscure the aspects of the disclosure. Similarly, well known components in a device may be omitted from figures and descriptions thereof presented herein in order not to obscure the aspects of the disclosure.

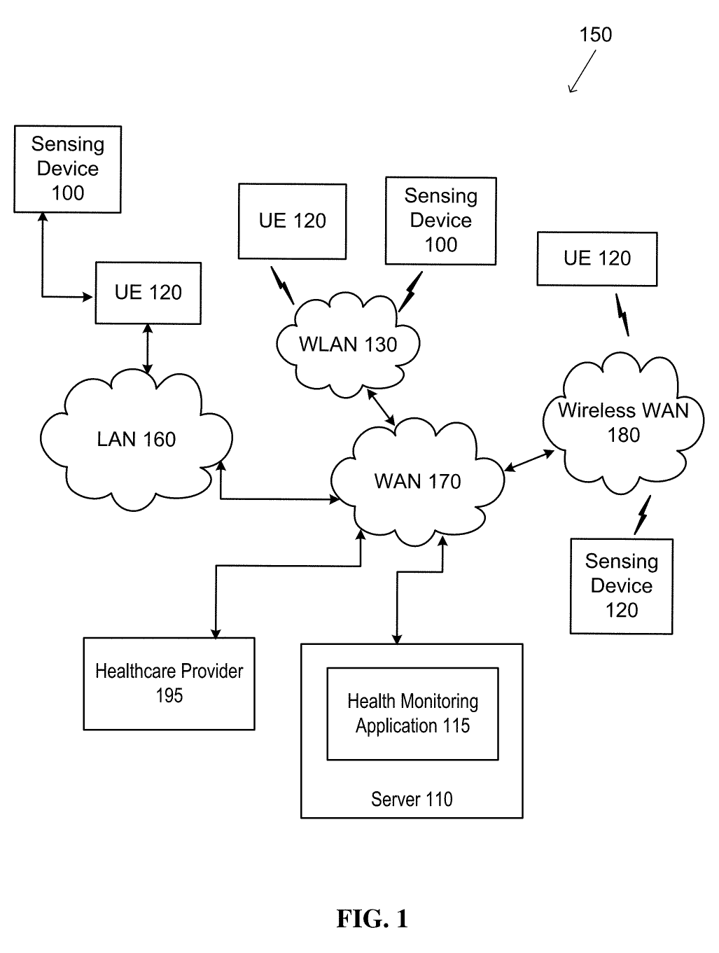

FIG. 1 illustrates a schematic block diagram of an embodiment of an exemplary network 150. The exemplary network 150 includes one or more networks that are communicatively coupled, e.g., such as a wide area network (WAN) 170, a wired local area network (LAN) 160, a wireless local area network (WLAN) 130, and/or a wireless wide area network (WAN) 180. The LAN 160 and the WLAN 130 may operate inside a residence or in an enterprise environment, such as an office building, retail store, hotel, restaurant, clinic or other facility. The wireless WAN 180 may include, for example, a 3G or 4G cellular network, a GSM network, a WIMAX network, an EDGE network, a GERAN network, etc. or a satellite network or a combination thereof. The WAN 170 includes the Internet, service provider network, other type of WAN, or a combination of one or more thereof.

User equipment (UE) 120 may communicate over the network 150, e.g., to one or more other UE 120 or to one or more sensing devices 100, to a server 110, to a healthcare provider 195, etc. The UE 120 may include a smart phone, laptop, desktop, smart tablet, smart watch, or any other electronic device.

Each of the sensing devices 100 are communicatively coupled to one or more of the UE 120 directly or through one or more of the exemplary networks. The sensing devices 100 are configured to identify and monitor various types of airborne particles in air samples from a location outside or inside. A sensing device 100 may be located in a residence or in an enterprise environment, such as a store, office, hotel, clinic, stadium or other facility. The sensing devices 100 may also be located outside in parks, streets, highways, tops of buildings, etc. In addition, a sensing device 100 may be located on trains, cars, planes or other modes of transportation. The sensing devices 100 are configured to monitor air samples and identify one or more types of airborne particles.

The sensing devices 100 may thus be used to detect levels of allergen and pollutants. For example, the sensing devices 100 may provide identification and levels of allergen and pollutants found locally outside, such as around a building, street, or one or more parts of a city. The sensing devices 100 may also provide identification and levels of allergen and pollutants found inside within a residence, work place, retail center, factory, stadium or other indoor area. Using the network, the identification and levels of allergen and pollutants found in other cities, states, countries or internationally may also be provided to users. The network of sensing devices also allows the users to compare levels of allergen and pollutants between an indoor area and outdoor area. Users with asthma, COPD or other health conditions may determine to limit outdoor activity when outdoor levels of allergen and pollutants are higher based on such comparison.

The identified airborne particles may include typical allergens such as pollen, ragweed, grass, rye, pet dander, birch, mold, Artemisia, etc. The identified airborne particles may also include pollutants, such as ozone, NOx, CO, Sox, etc. These listed types of particles are examples only and other types of particles may also be identified and monitored by the sensing devices 100.

The server 110 includes a health monitoring application 115. The health monitoring application 115 may be installed on or operable to communicate with the UE 120 and sensing devices 100. The health monitoring application 115 may be a web-based application supported by the server 110. For example, the server 110 may be a web server and support the health monitoring application 115 via a website. The UE 120 may access the functions and data of the health monitoring application 115 using a browser that accesses the server 110. In another embodiment, the health monitoring application 115 is a stand-alone application that is downloaded to the UE 120 and is operable on the UE 120 without access to the server 110 or accesses the health monitoring application 115 on the server 110 for additional information or data. The sensing devices 100 may also include the health monitoring application 115 or be operable to communicate with the server 110 to perform one or more functions described herein.

The one or more sensing devices 100 may communicate with the server 110 to perform one or more functions herein. Alternatively, the health monitoring application 115 and associated databases may be downloaded to a sensing device 100 such that the sensing device may be operable to perform one or more functions herein without communicating over the network 150.

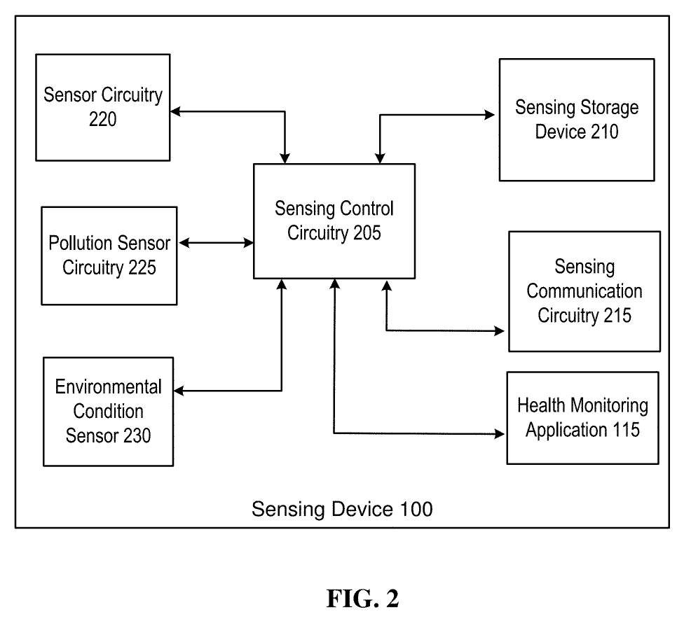

FIG. 2 illustrates a schematic block diagram of an embodiment of a sensing device 100. The sensing device 100 comprises sensing control circuitry 205. The sensing control circuitry 205 includes a processing circuit having one or more processing devices, such as a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

The sensing device 100 further includes a sensing storage device 210 that includes one or more memory devices, such as a read-only memory, random access memory, volatile memory, non-volatile memory, static memory, dynamic memory, flash memory, cache memory, and/or any non-transitory memory device that stores digital information. The sensing storage device 210 stores one or more instructions or programs which when performed by the sensing control circuitry 205, instructs the sensing control circuity 205 to control the sensing device 100 to perform one or more functions described herein.

The sensing storage device 210 is connected to the sensing control circuitry 205. The sensing storage device 210 stores, e.g. the health monitoring application 115 and a database including user profile information and, as will be explained further herein, particle signatures, associated symptoms and health advice. Information and data from this database may be provided to one or more of the UEs 120 to provide health information based on the detection and monitoring of types of particles by the sensing device 100.

Additionally connected to the sensing control circuitry 205 is sensing communication circuitry 215. The sensing communication circuitry is configured to communicate with UE 100 or to the server 110 over one or more of the exemplary networks in the network 150. For example, the sensing communication circuitry 215 may include a wired or wireless transceiver to communicate over a WLAN, WAN or cellular network.

Further connected to the sensing control circuitry 205 is sensor circuitry 220. The sensor circuitry 220 is configured to capture and analyze particles in air samples. In particular, the sensor circuitry 220 may identify airborne particles that can trigger an allergic reaction. For example, the sensor circuitry 220 is used to capture particles such as pollen or animal dander. These particles are captured by the sensing device in air samples from the habitat in which the sensing device 100 is located.

Additionally provided and connected to the sensing control circuitry 205 is pollution sensor circuitry 225. In a similar manner to the sensor circuitry 220, the pollution sensor circuitry 225 is configured to capture and analyze pollutants in the habitat in which the sensing device 100 is located. However, differently to the sensor circuitry 220, the pollution sensor circuitry 225 captures and identifies pollutants such as NOx and CO and other such pollutants. The sensor circuitry 220 and the pollution sensor circuitry 225 may include specially designed or off-the-shelf electrochemical or similar components, such as MEMs based sensors. Embodiments of the sensor circuitry 220 and the pollution sensor circuitry 225 are described in more detail herein.

In addition, the sensing device 100 may include an environmental condition sensor 230. The environmental condition sensor 230 includes various instruments, such as thermometer, barometer, etc. which measure environmental conditions such as humidity and temperature of the surroundings.

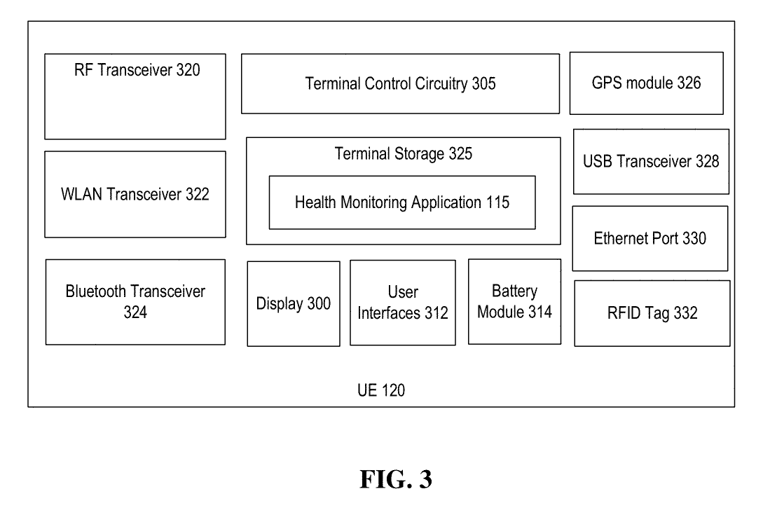

FIG. 3 illustrates a schematic block diagram of an embodiment of user equipment 120. The user equipment (UE) 120 may include a smart phone, smart tablet, laptop, smart watch, desktop, TV or other device. The UE 120 includes terminal control circuitry 305. The terminal control circuitry 305 includes a processing circuit having one or more processing devices, such as a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

Connected to the terminal control circuitry 305 is a display 300. The display 300 is an example of a user interface which allows the user to interact with the UE 120. The display 300 may include a touchscreen, LED or other type of display. The display 310 may be integrated in the UE 120 as is shown in FIG. 3 or may be separate to the UE 120. For example, the display 320 may be a computer monitor, television screen, or head mounted display. The display 320 enables a user to view data and graphical user interfaces as described herein. The UE 120 may include or be operably coupled to one or more other user interfaces 312 such as a mouse, keyboard, touchpad, voice recognition, or gesture recognition circuitry.

The UE 120 includes terminal storage 325 that is connected to the terminal control circuitry 305. The terminal storage 325 may include one or more memory devices, such as a read-only memory, random access memory, volatile memory, non-volatile memory, static memory, dynamic memory, flash memory, cache memory, and/or any non-transitory memory device that stores digital information. In addition, the terminal storage 325 may store one or more instructions or programs which when performed by the terminal control circuitry 305 may control it to perform one or more functions described herein. The terminal storage 325 stores a health care monitoring application 350. For example, the health care monitoring application 350 may instruct the terminal control circuitry 305 to execute logic to direct the UE 120 to present one or more graphical user interfaces (GUI). The GUIs present data generated by sensing device 100 or server 110 as well as GUIs to input user commands to control the sensing device 100.

The UE 120 may further include one or more of a Bluetooth transceiver 324, a WLAN (IEEE 802.11x compliant) transceiver 322, or a global positioning satellite (GPS) module 326. The UE 110 may also include an RF transceiver 320 compliant with Universal Mobile Telecommunications System (UMTS) Terrestrial Radio Access Network (UTRAN), Long Term Evolution (LTE) Evolved UTRAN (E-UTRAN), LTE-Advanced (LTE-A) or other wireless network protocols. The UE 120 may further include a USB port/transceiver 328, Ethernet Port 330 or RFID tag 332. The UE 120 may also include a battery module 314. One or more internal communication buses (not shown) may communicatively couple one or more of the components of the UE 120.

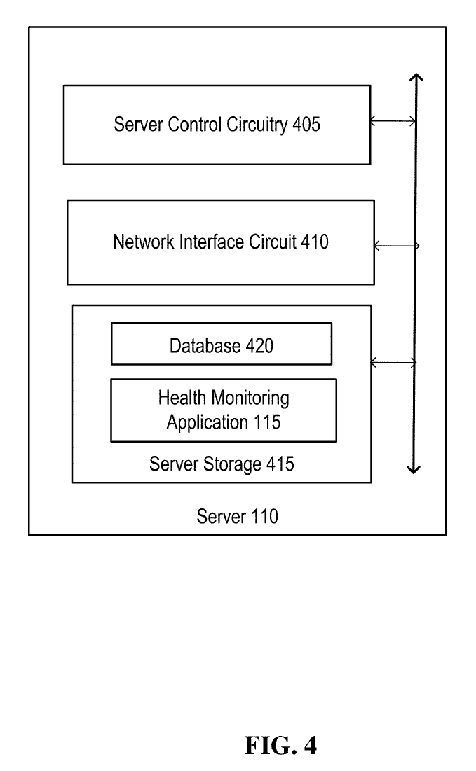

FIG. 4 illustrates a schematic block diagram of an embodiment of an exemplary server 110. The server 110 includes server control circuitry 405 which includes a processing circuit having one or more processing devices, such as a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The server includes server storage 415 that is connected to the server control circuitry 405. The server storage 415 may include one or more memory devices, such as a read-only memory, random access memory, volatile memory, non-volatile memory, static memory, dynamic memory, flash memory, cache memory, and/or any non-transitory memory device that stores digital information. In addition, the server storage 415 may store one or more instructions or programs which when performed by the server control circuitry 405 may perform one or more functions described herein.

The server 110 includes a network interface circuit 410 that includes an interface for wireless and/or wired network communications with one or more of the exemplary networks in the network 150. The network interface circuit 410 may also include authentication capability that provides authentication prior to allowing access to some or all of the resources of the server 110. The network interface circuit 410 may also include firewall, gateway and proxy server functions.

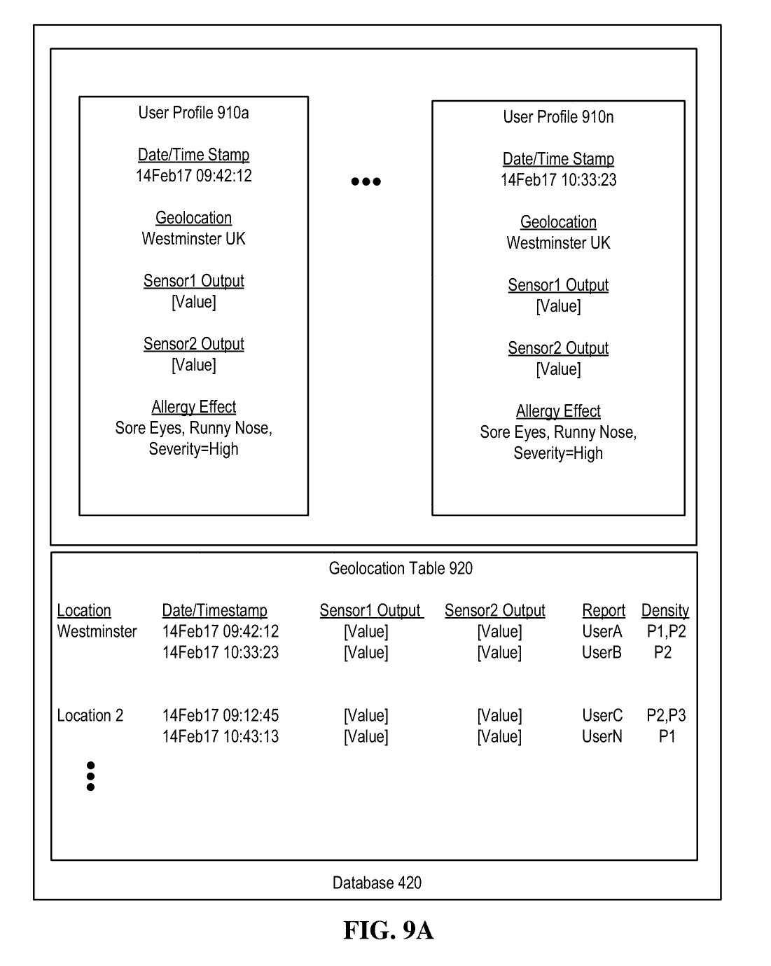

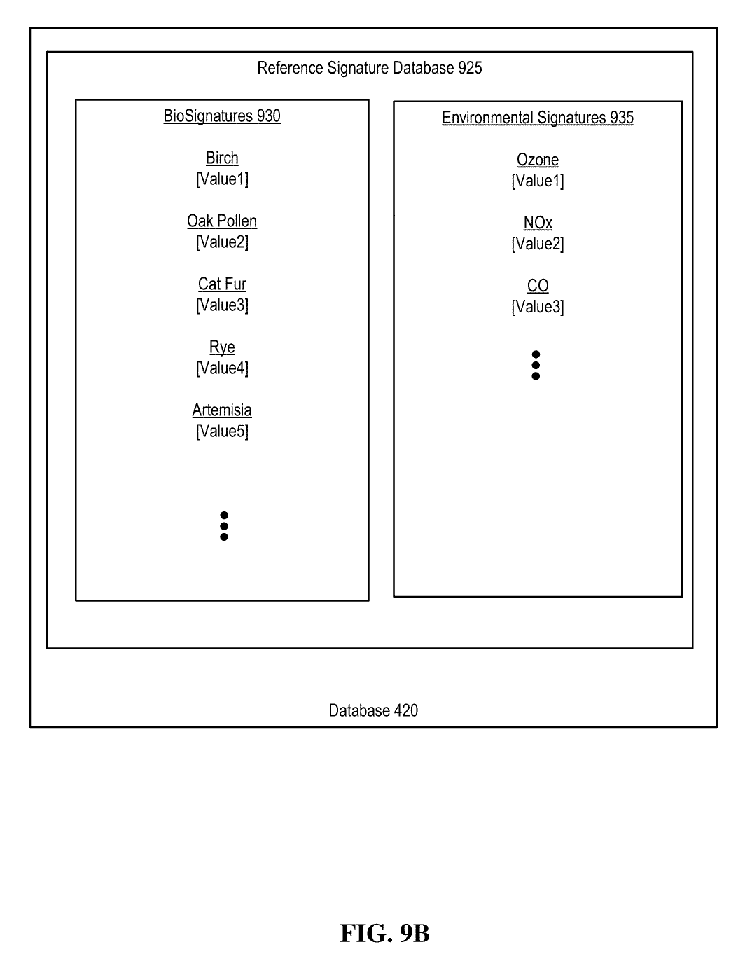

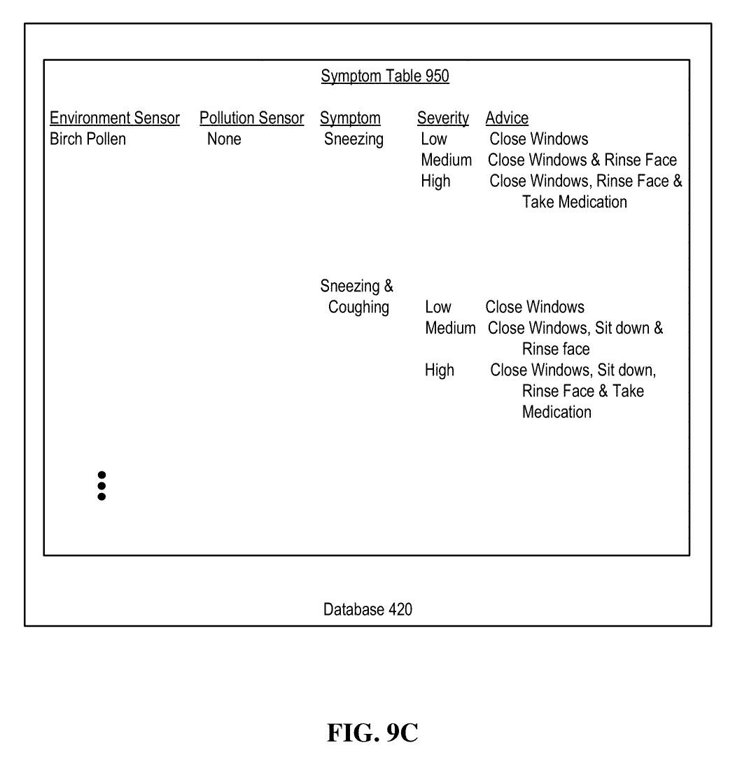

Additionally provided within the storage 415 is a database 420. The database includes user specific profiles stored for each user of the health monitoring application 115. Additionally provided in the database 420 is geolocation information associated with the output of the sensing devices 100. Further, various particulate (or particle) reference signatures are stored within the database 420. These reference signatures may include bio-signatures, environmental signatures or pollutant signatures. Finally, health advice, including medical or preventative advice, is stored in the database 420. The health monitoring application 115 is configured to provide the health advice to a user via the UE 120 in response to output from the sensing devices 100 and/or user input. The database 420 is described in more detail with reference to FIGS. 9A-9C.

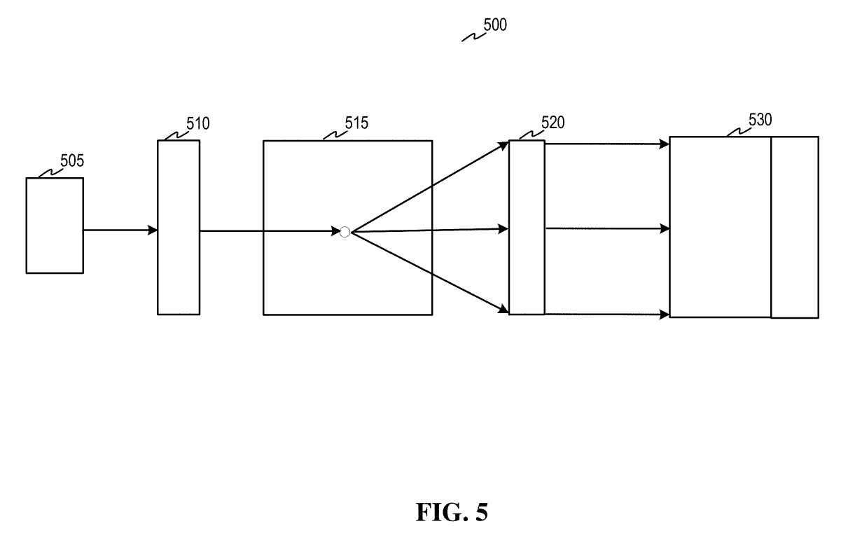

FIG. 5 illustrates a schematic block diagram of an embodiment of an exemplary sensor 500. The sensor 500 may be included as part of the sensor circuitry 220 in the sensing device 100. The sensor 500 is configured for identification of airborne particles. The sensor 500 includes a light source 505, a first optical filter 510, a temporary particle trapping system 515, a second optical filter and a detector.

In embodiments herein, the light source 505 may be a laser or laser diode that illuminates a particle in the temporary particle trapping system 515. The light source 505 includes laser diodes or light emitting diodes (LEDs) that emit light at one or more specific wavelengths or over a range of wavelengths. For example, in one embodiment, the light source 505 may emit light at one or more wavelengths in a range of 450 nm to 785 nm depending on a type of particle to be identified. The first optical filter 510 may be embodied as a single line laser filter that filters all but one or more predetermined wavelengths or dichroic mirrors or Volume Bragg Grating.

The temporary particle trapping system 515 is configured to immobilize a particle (e.g., the particle being represented by the black dot in FIG. 5) in an air sample. In some embodiments, the temporary particle trapping system 515 is optional. For example, with slow or minimal airflow through the sensor 500, it is possible to perform the analysis of a particle without immobilizing the particle within the particle trapping system 515.

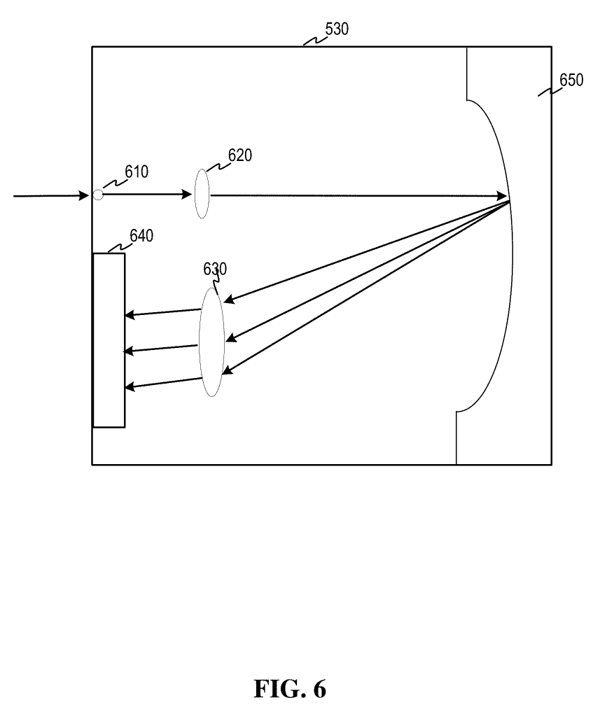

The second optical filter 520 may be a notch filter having a notch corresponding to a same wavelength as the first optical filter 510 or Rayleigh filtering. The detector 530 obtains a spectral response of the reflected light, and may include one or more types of spectrometers. The detector 530 may be any suitable type of detector which is known to the skilled person, such as a spectrometer. The detector 530 is configured to detect an intensity of light as a function of wavelength in a light range of interest which, in embodiments, is between the ultraviolet to the infrared range. The wavelength range depends on the type of particles and the particular spectral properties of the particles to be identified by the sensing device 100. The detector 530 will be described further with reference to FIG. 6.

In operation in one or more embodiments herein, the sensor 500 controls the light source 505 to emit light at one or more wavelengths. The light impinges upon the first optical filter 510. Assuming that the light is approximately spatially invariant over the area of the first optical filter 510, the light passing through the first optical filter 510 is reduced to a single wavelength of light. The light then interacts with an air sample in the optional temporary particle trapping system 515. The biological, physical and chemical characteristics of a particle in the air sample affects the light. For example, the particle in the air sample interacts with the light and shifts the light to one or more different frequencies.

The light then impinges upon the second optical filter 520 and the wavelength corresponding to the laser (or the first optical filter 510 if present) is filtered and does not pass through the second optical filter 520. The shifts in the wavelengths of the light due to the type of particle and their intensity are recorded by the detector 530 as a spectral response. For example, the detector 530 may be a spectrometer configured to detect an intensity of light in the UV and/or IR range. In this embodiment, the spectral response is recorded as a function of position (pixel number) on the detector 530 and is correlated to an intensity at the wavelength of the light corresponding to that position. In some embodiments of the disclosure, an additional filter is placed next to the second optical filter 520 and before detector 530 in order to filter light which may lie outside the spectral range of interest. This additional filtering prevents unwanted light from reaching the detector 530. The spectral response includes an intensity as a function of wavelength or frequency shifts. The spectral response detected depends on the type of particle. Thus, by comparing the detected spectral response to predetermined or stored spectral patterns or signatures of a particle, the type of particle in the air sample may be identified.

It will be understood that spectrometers according to other embodiments may be implemented in the sensor 500. The choice of light source, detectors and associated optics for use with a wide variety of spectroscopic techniques may be implemented in the sensor 500. For example, Raman, fluorescents and infrared or ultraviolet reflectance spectroscopies may be implemented as well as Fourier Transform Infrared Spectroscopy. In an embodiment, the sensor 500 may be configured to separate a Raman signal from a florescence signal, such that a same spectrometer may be used to detect both types of spectral responses.

In an embodiment, the sensing device 100 also measures the amount of a particular allergen in the environment. For example, a particle counter may be implemented to count the number of particles of a certain size. The particle counter, if provided, may be located in the sensor 500 or in another location either within the sensing device 100 or in communication with the sensing device 100. However, one drawback with the particle counter is that some allergens can be of a similar size to other allergens or dust such as skin flakes shed by a human. The known particle counters do not distinguish between different types of allergen and non-allergens of a similar size; only the size of the particle is measured and not the composition of the particle. In this case, the particle counter may count other types of allergens or non-allergen particles as a same type of allergen particle and provide inaccurate readings.

In order to mitigate this problem, the sensor 500 may be configured to determine the number of particles of a particular type of allergen. The sensor 500 detects a number of readings of a particular allergen per hour and an airflow within the sensing device 100. From this information, the sensing device 100 may obtain a concentration of types of particles (such as parts per million PPM) with more accuracy. This information may also be provided to the server 110.

FIG. 6 illustrates a schematic block diagram of an embodiment of an exemplary detector 530. In an embodiment, the detector 530 includes a spectrometer. The incident light passes through an input slit 610 at a certain angle. A collimating lens 620 collimates this slip transmitted light and guides it onto a grating 650. The grating 650 separates the incident light into different wavelengths and reflects the light at each wavelength at a different diffraction angle.

A focusing lens 630 focuses an image of the light spatially dispersed into wavelengths by the grating onto linearly arranged pixels of an image sensor 640. The image sensor 640 converts the optical signals, which were dispersed into wavelengths by the grating 650 and focused by the focusing lens 630, into electrical signals. This provides a “count” of photons of light or intensity of light at each of the plurality of wavelengths to generate a spectral response or signature. These values of the intensity of light versus wavelength are then output. The output of the image sensor 640 is described in more detail herein.

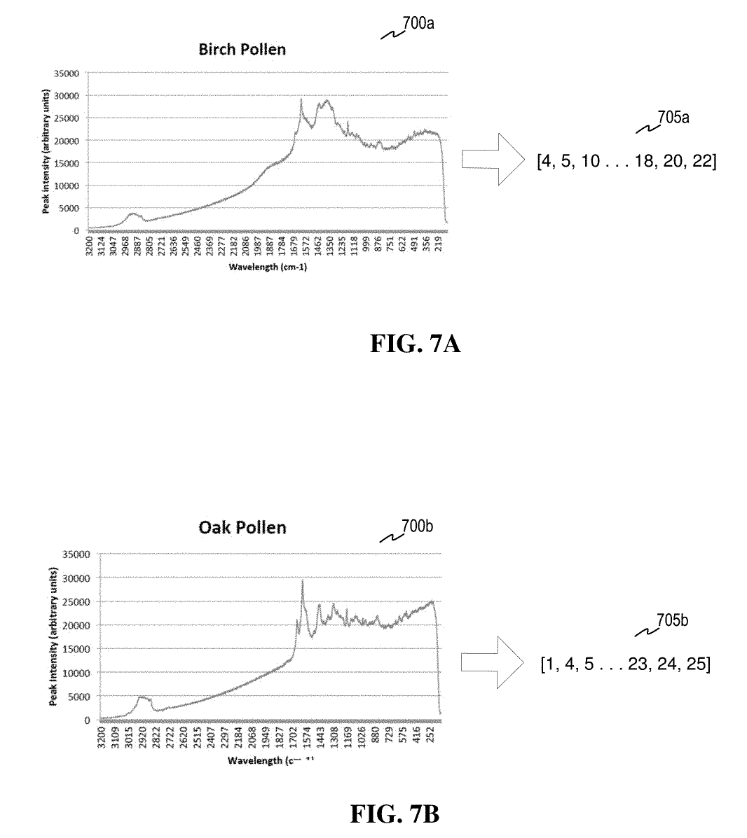

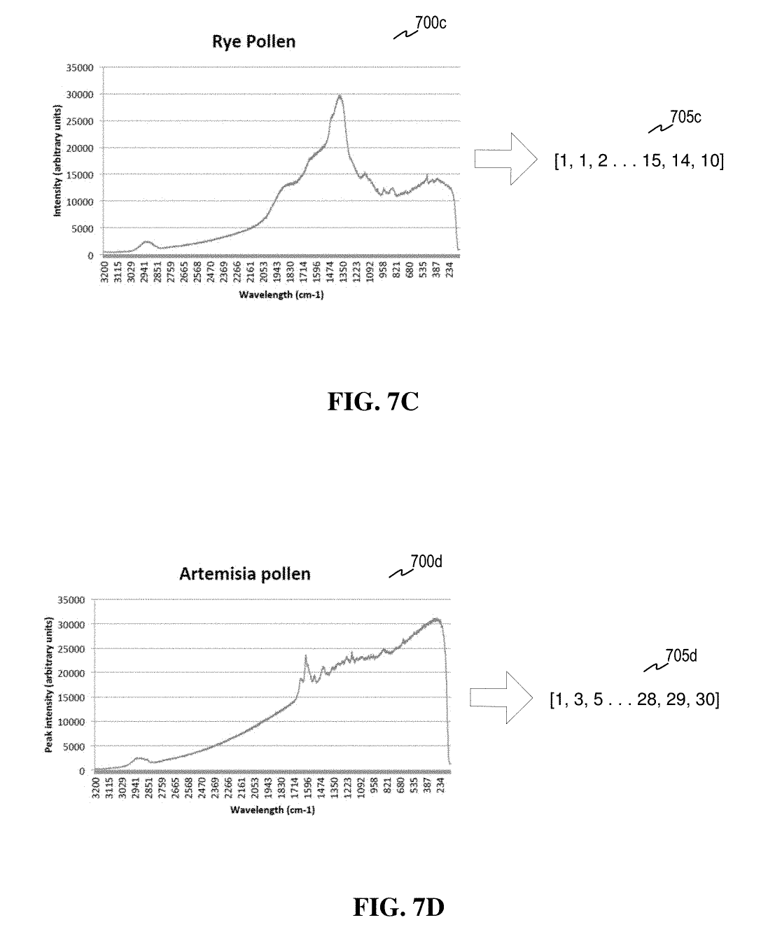

FIGS. 7A, 7B, 7C and 7D illustrate graphical diagrams of embodiments of reference spectral signatures for various particles. Referring to FIG. 7A, a spectral signature for a birch pollen particle is shown in graph 700a. On this graph, the intensity of the light (the count of photons) is plotted on the ordinate of graph 700a and the wavelength of the photons is plotted on the abscissa of the graph 700a.

In other words, the graph 700a shows the intensity of light at various wavelengths when a sample of birch pollen is tested using an embodiment of the sensor 500, e.g. such as described with respect to FIG. 5 and FIG. 6. As will be apparent to the skilled person, the output graph 700a is characteristic of a spectral response for a particle of an environmental allergen. In this case, the environmental allergen is a type of pollen and, specifically, birch pollen. FIG. 7B illustrates a second graph 700b of the spectral signature or response of Oak pollen obtained by an embodiment of the sensor 500 described with respect to FIG. 5 and FIG. 6.

In order to derive these reference spectral signatures, firstly, a sensor 500 is calibrated by analyzing the laser light when no sample is included in the sensor of FIG. 5. This is termed the “dark mode” by a person skilled in the art. This produces an output which is then used to compensate the output when a sample particle is placed into the sensor of FIG. 5.

After the output from the “dark mode” is derived, a sample particle is processed by the sensor 500 using an embodiment of a process, e.g., described with reference to FIGS. 5, 6 and 10. The output of the process with the sample is compensated by the dark mode output. This compensated result is the reference spectral signature for one sample of a particle, e.g. such as birch pollen.

In order to improve the accuracy of the reference spectral signature for a particle, different samples of the particle are subjected to the analysis by the sensor 500. Again each output of the process is compensated by the dark mode output. The reference spectral signature is then derived from the spectral responses of the plurality of known samples of the particle. Typically, in excess of 10 sample signatures or a statistically significant number of sample signatures of a known particle, are obtained to derive a reference spectral signature. For example, the reference spectral signature may be selected as a median of the sample spectral signatures. By selecting a median sample signature, anomalies with a particular sample signature are mitigated. Of course, other mechanisms for mitigating such anomalies, such as using the mean or average of the intensity at each wavelength, may be implemented to determine the reference spectral signature for a particle.

After the reference spectral signature 700a is derived for birch pollen, the intensity of light at predefined wavelengths is determined, e.g. spectral lines. The spectral lines may be represented and stored as a matrix or vector 705a. In other words, for each wavelength value (for example every 10 nm), the intensity of the light at that wavelength is stored as a representative number in the vector 705a. The wavelength value may be linearly divided across the entire range. For example, each number in the string may be the intensity at every lOnm wavelength. However, the disclosure is not so limited, and the wavelength value may be logarithmically divided across the entire range. The reference spectral response 700a may thus be numerically represented and stored.

An example vector for the birch pollen is shown at 705a. In particular, the intensity values at predefined wavelength values in the reference signature graph 700a are obtained and represented as an array or vector or string of numbers. This vector may include a plurality of intensity values, e.g. 128 intensity values may be represented for 128 different wavelength values. Of course, any suitable number of values may be chosen. Also, although only the first three numbers and the last three numbers of the vector 705a are illustrated in this example, the vector may include any number of intensity values over a range of predetermined wavelengths in the reference signature graph 700a. As noted above, the predetermined wavelengths may be evenly spaced along the reference signature graph 700a or in other embodiments, more intensity values may be selected around specific wavelengths or in a wavelength range with a high variability.

Referring now to FIG. 7B, similar features exist in the graph of the reference spectral signature of Oak pollen 700b. The spectral signature 700b may again be converted into a numerical representation, such as an array or vector 705b. The array 705b is illustrated in this example using just the first three and last three numbers for convenience. Again, this vector may include 128 values or may include more or less values. These reference spectral signatures 700a and 700b define unique particle characteristics of birch pollen and Oak pollen respectively. Therefore, any particle measured by the sensor 500 having similar spectral characteristics may be identified as birch pollen or Oak pollen respectively. The reference spectral signatures for a plurality of particles, each defining unique characteristics, is stored in the database 420 within server 110.

With reference to FIG. 7C, the spectral signature of Rye pollen defining its characteristics is shown in reference signature graph 700c. The reference signature graph 700c is represented as a vector 705c similar as described with reference to FIG. 7A and FIG. 7B.

Similarly, with reference to FIG. 7D, a reference signature graph 700d illustrates an example of the spectral signature of Artemisia pollen. The reference signature graph 700d is represented as a vector 705d similar as described with reference to FIG. 7A. The reference spectral signatures of FIGS. 7A-7D may be obtained using the sensing device 100 according to embodiments described herein or by using a different device or method.

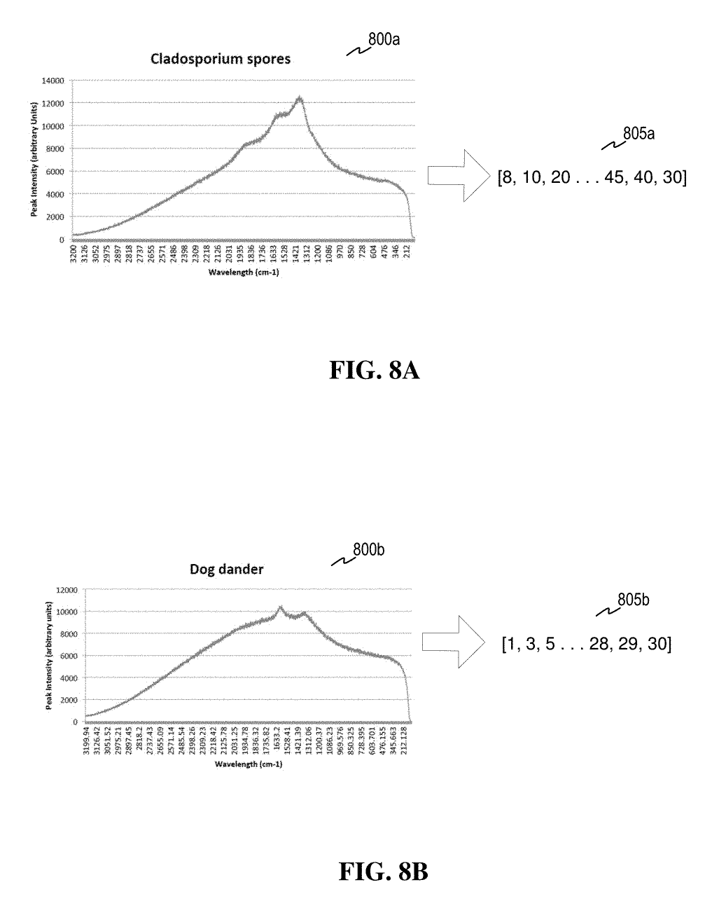

FIG. 8A and FIG. 8B illustrate a schematic block diagram of an embodiment of exemplary spectral signatures for various other particles. The sensing device 100 located in a dwelling or business may analyze an air sample to identify a type of particle. During this sensing process, the spectral signature of the particle is obtained using the sensor 500 within the sensing device 100. The sensing process may be initiated by a user or may be performed periodically or may be initiated by some other mechanism. For example, the sensing process may be performed periodically every 15 minutes or every hour, at the same times each day to monitor the presence of airborne particles.

Referring to FIG. 8A, it illustrates a schematic block diagram of an embodiment of a signature for Cladosporium spores under test. An example output of the sensor 500 is shown in spectral signature graph 800a for Cladosporium spores. The spectral signature graph 800a from the sensor 500 may be numerically represented by vector 805a. The method for deriving the vector 805a from the spectral signature graph 800a is similar to that described above.

In an embodiment, the spectral signature graph 800a and/or vector 805a are transmitted to the server 110 over the network 150. The vector 805a is compared with the reference spectral signatures stored within database 420. The server control circuitry 405 analyses the vector 805a obtained from the sensing device 100 and compares this spectral signature with the vectors of the reference spectral signatures stored in database 420.

Though vectors are described herein as numerically representing the spectral signatures, other representations may be derived. For example, an M×N matrix, a spectral pattern, or other representation may be used. Various techniques for comparing a measured spectral signature and reference spectral signatures may also be implemented, including, e.g. pattern recognition, matched filters, correlation filters, Gabor filters (with Gabor wavelets, log-Gabor wavelets), Fourier transforms or other algorithms may be used to compare the spectral signatures.

The server control circuitry 405 then determines whether the received vector 805a corresponds to a stored reference signature vector. In the event that the received vector 805a does correspond to a stored reference signature vector, the identity of the particle is then returned to the sensing device 100 or UE 120 associated with the sensing device 100 or its location. In addition, health advice based on the identified particle may be provided to a user, wherein the health advice may reduce the impact of the identified particle on the user. This health advice may further be dependent upon an input of a severity of symptoms and type of symptoms suffered by the user.

Referring to FIG. 8B, it illustrates a schematic block diagram of an embodiment of a signature for Dog dander under test. The Dog dander spectral signature that is an output of the sensor 500 is shown in the second graph 800b. The second spectral signature graph 800b may be represented using vector 805b. The vector 805b is transmitted from the sensing device 100 to the server 110 over the network 150. The sever control circuitry 405 then compares the received vector representative of the spectral response of the particle to the stored reference signatures. The server control circuitry 405 determines whether the received vector 805b corresponds to a stored reference signature. If the comparison is favorable, the identity of the particle is returned to the sensing device 100 and/or UE 120 and may also be used to generate health advice. Again the health advice provided may also be dependent upon an input of the symptoms and severity of the symptoms suffered by the user.

In another embodiment, machine learning techniques are used to generate a training dataset for a reference spectral signature. The spectral signature is analyzed with a training algorithm to generate a vector or unique identifier. The training algorithm may include one or more of matched filters, correlation filters, Gabor filters (Gabor wavelets, log-Gabor wavelets) and/or Fourier transforms. A spectral response template for a particular type of particle is generated, e.g. that includes an array with intensity levels and wavelengths as coordinates.

A sever control circuitry 405 compares a measured spectral response with the reference spectral response templates. Again, matched filters, correlation filters, Gabor filters (with Gabor wavelets, log-Gabor wavelets) and Fourier transforms can be used to perform the comparison between the spectral response vector and subset. Based on the comparison, the sever control circuitry 405 generates a quality assessment value. In another embodiment, a multi-layered neural network can be implemented to process the spectral response and determine a type of particle.

Though the above embodiments describe the server control circuitry performing the comparison, the sensing device 100 may store reference spectral signatures and perform the comparison. The graphs and vectors are merely exemplary and other vectors or numerical representations may actually be implemented herein.

Referring to FIGS. 9A, 9B and 9C, various embodiments of a database 420 stored within the server 110 or sensing devices 100 is shown. FIG. 9A illustrates a schematic block diagram of an embodiment of the database 420 with a plurality of user profiles 910a-n and a geolocation table 920. The database 420 stores one or more user profiles 910a-n including information for users registered with the server 110. Typically, this registration occurs when a user buys a sensing device 100 and/or downloads an application program used to control the sensing device 100 to a UE 120. The user profile 910a-n may include known allergies, age, gender and other relevant medical history associated with that particular user. Additionally, the results of the output from the sensing device 100 are also stored within the user profile of database 420. In particular, as seen in FIG. 9A, the date and time of each sensor measurement by the sensing device 100 is stored. Additionally, the location of the sensing device 100 when that sensor measurement took place is also stored. The location may include, as in this case, a borough of a larger town or, may be, geographical coordinates identifying the exact location of the sensing device 100. Also provided and stored in correspondence with this information is the sensor output from one or more sensors in the sensing device 100 at that location.

In addition, symptoms logged by the user of the UE 120 are also stored in correspondence with the sensor outputs. For example, in user profile 910a, the symptoms logged by the user includes sore eyes and a runny nose. The user input also includes that the severity of these symptoms is a high severity. In other words, when the user is exposed to the particles analyzed by the sensor 500, the user suffers these symptoms with a high severity. The symptoms may be due to allergies or asthma or other health conditions.

Additionally stored in the database 420 is information pertaining to the particular geolocation. In this example, a borough of London (Westminster) is the geolocation. However, it is appreciated that any level of granularity is anticipated. For example, the geolocation may be instead geographical coordinates within a small range or area of a particular location or may be a very precise geographical location.

The date and time stamp of each sensor measurement at that location is stored in association with that location. Moreover, with each sensor measurement, the results from the sensor 500 are stored in association with that particular sensor measurement. This allows for any location wherein sensing devices 100 are positioned to monitor the environmental and pollution particulates. The sensing device 100 may be configured to perform a measurement in accordance with one or more settings. For example, the sensing device 100 may be configured to perform a measurement periodically (for example every 15 minutes, 30 minutes, hour or the like). The sensing device 100 may be configured to perform a measurement at the same time every day (e.g, at 10 am, 11 am, 1 pm, 3 pm, etc). The sensing device 100 may also be configured to perform a measurement every time a user logs symptoms with the UE 120 or upon request by a user of the UE 120.

The sensor 500 is configured to determine the number of particles of a particular type of allergen. The sensor 500 detects a number of readings of a particular allergen per hour and an airflow within the sensing device 100. From this information, the sensing device 100 may obtain a concentration of a particular allergen or pollutant or other particulate with more accuracy. This information may also be provided to the server 110 and stored in the geolocation table 920. For example, a density of particles P1 and P2 is recorded for Westminster associated with a first sensing device 100 for UserA. A density of particles P2 is recorded for Westminster associated with a second sensing device 100 for UserB.

The geolocation table 920 may thus include a density of one or more types of particles detected at each location (density of particles P1, P2, P3, etc.) during a time period. This record enables trends for particular locations to be monitored and data collated for local authorities and government to monitor allergens, pollutants and other particulates that may have an impact on public health. This is particularly useful where high levels of a pollutant such as fine particulate matter are reported in a particular residential location where the impact on public health may be significant. Further, as this data is collected from the sensing devices 100 which are, in embodiments, located in a dwelling, the local authorities and government will have data from inside dwellings. This kind of data is not normally accessible to public bodies and is actually more representative of the allergens and irritants to which people are exposed on a daily basis.

In addition to this information, an identifier of the sensing device 100 reporting this information is stored in association with the sensor measurement. For example, in geolocation table 920 shown in FIG. 9A, a first sensing device 100 reported an output of its environmental sensor circuitry 220 (Sensor1 output) and its pollution sensor circuitry 225 (Sensor2 Output) with respect to a report for UserA in Westminster. Another sensing device 100 also located in in Westminster associated with a UserB (e.g., another individual, entity, or a government agency) is noted as being in this locality. This second sensing device 100 also provides a report of sensori output and sensor2 output. The plurality of sensing devices 100 in a location allows councils and other local authorities to provide sensor measurement, from, for example street-side. In addition, this allows other user's sensing devices in this particular locality to provide crowd sourced information relating to pollutants and allergens within a user's home and locality. This collective information is very useful. For example, if a particle signature does not match a stored reference signature found at a particular locality and users complained of an allergic effect associated with this particle, the signature of that particle may be stored in the database 420 and health advice determined whilst the identity of the particle is established.

FIG. 9B illustrates a schematic block diagram of an embodiment of the database 420 including a reference signature database 925 for one or more types of particles. In particular, Biosignatures 930 stores reference signatures [Value1, Value2, Value 3, Value4, Value5, etc.] for one or more sample particles [e.g., birch, Oak pollen, cat fur, rye, Artemisia, etc.]. The reference signatures may be included as a numerical signature string or vector associated with each sample particle and its identity is stored. In other embodiments, the reference signatures may be patterns of the spectral signatures or other representations. In the example of FIG. 9B, the reference signature for birch, grass pollen, Rye pollen, Artemisia pollen and cat dander is stored. In addition, environmental signatures 935 for pollutants such as nitrous oxide, carbon monoxide and ozone are also stored as part of the reference signature database 925.

FIG. 9C illustrates a schematic block diagram of an embodiment of the database 420 including a symptom table 950. For example, the symptom table 950 stores advice in response to detection of one or more types of particles. Typically, the advice is provided to a UE 120 associated with a user and displayed on a terminal display 300.

In the non-limiting example, it is noted that the sensor 500 identifies a particular type of allergen such as birch pollen. A user may input one or more symptoms and a severity of symptoms in a GUI of the health monitoring application 115 using either the sensing device 100 or the UE 120. The symptom table 950 lists associated advice for the input symptoms, severity of symptoms and type of allergen or other particulate.

The health advice is pre-stored, e.g. based on medical assistance. For example, the health monitoring application 115 obtains an identification of various particles (allergens, pollutants or other types of particles) from a sensing device 100 and stores corresponding symptoms input by a user associated with those pollutants and allergens. Depending upon the severity of symptoms identified by the user, using either the UE 120 or the sensing device 100, appropriate advice to reduce the impact of the identified particle which is pre-stored in the database 420 is returned to the UE 120.

In other instances, contact details for a medical practitioner (who specializes in the particular allergy and who is in the location of the user) are provided in addition to or instead of the advice. This may be appropriate, e.g., if the user is suffering severe allergic symptoms. Indeed, the user history and current symptoms and severity from the database 420 may be simultaneously provided to the medical practitioner. This will alert the medical practitioner to the user's allergic reaction and the allergens present in their surroundings. This may assist in the medical treatment given to the user. In really severe cases, the emergency services may be automatically dispatched to the geolocation of the user.

The network of sensing devices also allows the system to compare levels of allergen and pollutants between an indoor area of the user and an outdoor area near a user. For example, the health advice may include a caution to limit outdoor activity when the outdoor levels of allergen and pollutants are higher than indoor levels based on such comparison. Users with asthma, COPD or other health conditions may then determine to limit outdoor activity.

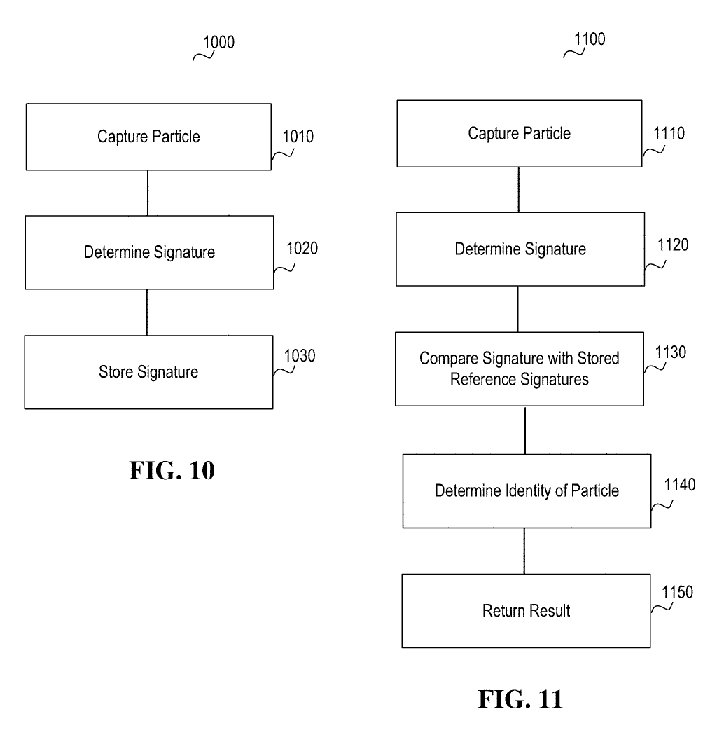

FIG. 10 illustrates a logical flow diagram of an embodiment of a method 1000 to obtain a reference signature of a particle. A sample particle is captured in the sensor 500 at 1010. The sensor 500 determines a spectral signature at 1020 of the sample particle. A representation of the spectral signature, e.g. such as a vector or other numerical reference signature that characterizes the spectral signature of the particle, may be derived. As described previously in respect of FIG. 7A, a reference signature may be derived after a number of sample particles have been analyzed. In the example of FIG. 7A, the median sample value is taken as the reference signature and the numerical reference signature is derived. The numerical reference signature is stored in database 420 at 1030.

FIG. 11 illustrates a logical flow diagram of an embodiment of a method 1100 to apply to a particle under test. The sensor 500 captures a particle at 1110. The sensor 500 processes the particle and determines a spectral signature of the particle at 1120. This spectral signature, as explained with reference to FIG. 8, may be represented as a numerical value such as a vector (which is a sequence) that is then provided to the server 110. This vector or other numerical representation of the spectral signature may be provided to the server 110 over the network 150 directly by the sensing device 100 or the UE 120.

The spectral signature is then compared with the reference spectral signatures stored in the database 420 at 1130. On the basis of this comparison, the identity of the particle may be determined at 1140. Of course, if no particle match occurs, then a “no match” result is returned to the sensing device 100 or the UE 120. After the identity of the particle has been determined, the result is returned to the sensing device 100 and/or the UE 120 in step 1150. The result is then displayed to the user via the terminal display 320.

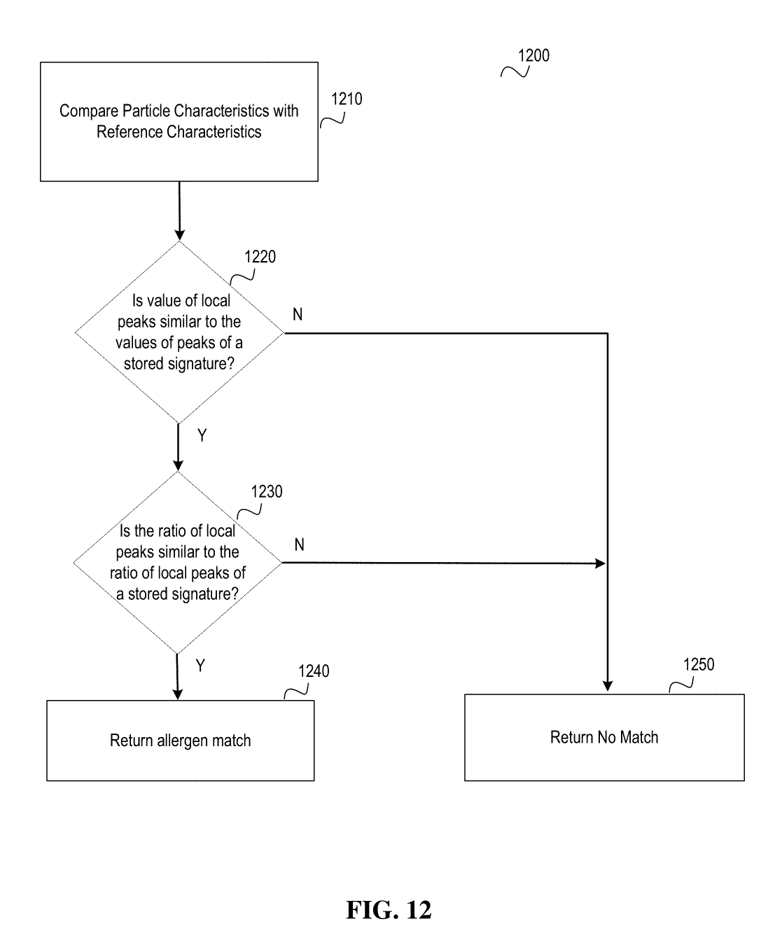

FIG. 12 illustrates a logic flow diagram of an embodiment of a method 1200 for determination of a type of particle. The method 1200 for comparing a signature of a particle with stored reference signatures is described in more detail. The analyzed particle characteristics from the sensing device 100 are compared with the stored reference characteristics within the database 420 at 1210. This comparison may be performed using one of several techniques. In this non-limiting embodiment, this comparison is carried out on a shape comparison basis using two steps.

In a first step, the values of local peaks in the spectral signature and reference spectral signatures are compared at 1220. For example, the wavelength and intensity of local minima and maxima are identified and these values (both the intensity and wavelength values) of the spectral signature under test and the reference spectral signatures are compared, e.g. on a peak by peak basis at a plurality of wavelengths. In this non-limiting instance, the peak intensity value at a plurality of wavelength values in the spectral signature under test is compared to the intensity value at a plurality of wavelength values in the reference spectral signatures.

In the event that the comparison of these values is within a predetermined threshold, the “yes” path is followed to step 1230. Alternatively, if the value of the local peak values are not within this threshold, the “no” path is followed to step 1250 wherein the process indicates that no match was found. In one non-limiting embodiment, the threshold is ±1%, although other thresholds are envisaged.

In the event that the “yes” path is followed at 1220, the shape of the spectral signature of the particle under test is compared to the shape of the reference spectral signatures at 1230. For example, a ratio of the local peak values in the spectral signature of the particle under test is compared to the ratio of the local peak values in the reference spectral signatures. In other words, the relative heights (and associated wavelengths) of the local maxima and minima in the captured particle spectral characteristics are compared with the stored reference spectral characteristics.

In the event that the ratio of the local peaks of maxima and minima of the signature of the particle under test is not similar to the stored reference signatures, the “no” path is followed to step 1250 where the process ends. On the other hand, if the ratio of the local peaks of the maxima and minima is similar, the “yes” path is followed to step 1240 wherein the identity of the particle is returned to the sensing device 100 or the UE 120 as required.

One mechanism for determining whether the signature of the particle under test is similar to the reference signature is to represent the spectral signatures as vectors and perform the dot product between each reference spectral signature in the database and the spectral signature of the particle under test. The intensity at each data point of the signature of the particle under test is multiplied by the intensity at the equivalent data point in the reference signature from the database 420. The more similar the two signatures are, the higher the value of the dot product, which is known as the score or the hit quality index. This calculation method is known as the correlation algorithm. The server control circuitry 405 is configured to obtain the dot product between the signature of the particle under test and a plurality of reference signatures in the database 405, and then report the first 50 hits, with the signatures listed in the order of decreasing value of the score. The server 110 then returns the signature with the highest value that is above a predetermined threshold.

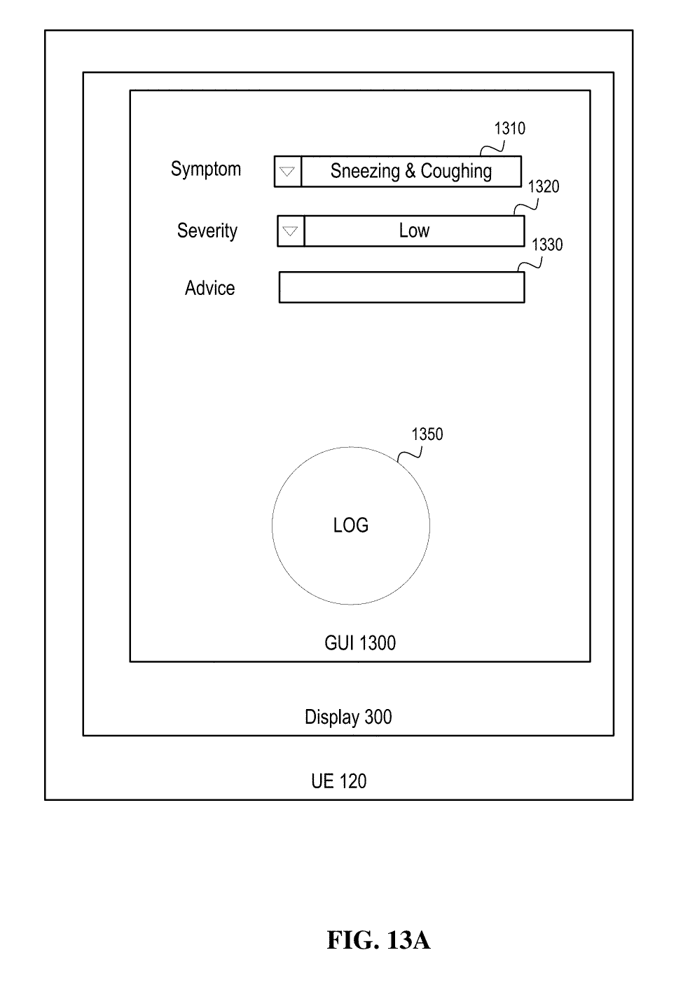

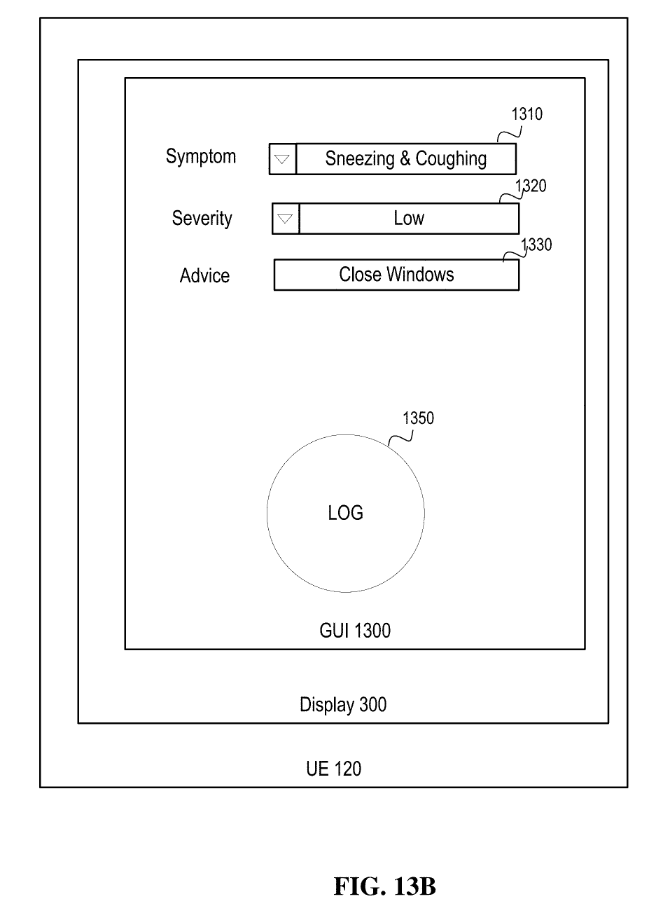

FIG. 13A and FIG. 13B illustrate schematic block diagrams of embodiments of a graphical user interface 1300. The graphical user interface 1400 may be generated by a UE 120 or a sensing device 100 using a health care monitoring application 350. Referring to FIG. 13A, a UE 120 having a display 300 with a graphical user interface (GUI) 1300 is shown. Using this GUI 1300, a user may select the symptoms from which they are suffering. The display and GUI 1300 may be integrated into the sensing device 100.

In the example embodiment, the GUI 1300 includes a dropdown menu highlighting various symptoms associated with allergies 1310. Of course, other types of user interface are envisaged such as a keypad or radio buttons or the like. The GUI 1300 also includes a dropdown menu for selection of a severity of allergic symptoms 1320. In this example, the user has indicated that their symptoms include sneezing and coughing, and the symptoms are of a low severity.

The GUI 1300 further includes an initiate or “log” button 1350. The UE 120 then instructs the sensing device 100, and specifically, the sensing control circuitry 205 via the sensing communication circuitry 215 to perform a sensing measurement. The sensing device 100 captures particles and obtains an identity of one or more particles. The database 420 is accessed and based on the identified one or more particles and the symptoms, advice is then returned to the UE 120. The advice appears in box 1330.

In the example of FIG. 13B, advice 1330 is displayed as noted in the database 420. In this example, the advice 1330 includes that the user should close the window.

The above describes the user logging symptoms and the UE 120 or the sensing device 100 returning advice. The disclosure is not so limited. In embodiments, the UE 120 communicates with the server 110, and the server 110 links the environmental factors with patient symptoms. Thus, in embodiments, the interaction between different allergens and pollutants and the symptoms of one or more health problems, such as asthma and allergy, are correlated.

In this embodiment, the patient logs the symptoms from a list of the symptoms (using the drop down menus of FIGS. 13A and 13B for example). These symptoms may be validated by a health professional before being provided in the drop down menu. The user then provides the intensity of the symptoms and the impact on his or her daily activities. For example, the symptoms may impair sleep, restrict the ability of the user to work or play sport etc. In other words, the severity of the outbreak may be judged. When the user logs this information, the sensing device 100 measures the levels of one or more of pollution, allergen and environmental factors (such as temperature, humidity, etc.) and communicates this information to the server 110.

This information from one or many users is then analyzed using a statistical tool, such as Principle Component Analysis, to determine one or more particulates that correlate with the logged symptoms. The server 100 may then determine which one or more particulates (pollution, allergen or other environmental factor) are likely causes of the symptoms. This information allows the user to be aware of the factor or allergen that is causing his or her symptoms. These symptoms may be stored in the database 420 in association with the user and the associated one or more particulates. Accordingly, this information allows the user to identify the allergens that cause various symptoms for the user. This information is useful if the user is to attend a medical clinic as the clinician can review the symptoms experienced by the user and identify the allergen or factor present at the time of the symptom appearing and the time of day that the symptom appeared. This health monitoring application 115 may thus be used as an allergy diary and that known allergy diaries are no longer required. The health monitoring application 115 records the allergen and/or other factors and the symptoms for the user.

In addition, in embodiments, prediction of long term allergy or asthma symptoms is performed by the health monitoring application 115. Specifically, once the allergen and other factors which trigger a user's symptoms are determined, future symptoms over the next few days, weeks and months can be predicted. In order to achieve this, long term weather and pollution forecasts are used, in conjunction with historical data, to predict the fluctuation in levels of pollution and allergen for a given geolocation. This information is used to indicate to a user (based at a geolocation) whether they will suffer allergic symptoms over the next few days, weeks or months. Additionally, advice may be provided to the user in order to reduce the severity of the symptoms or even avoid the outbreak altogether by improving the air quality. In summary, the health monitoring application 115 may notify or warn the user of a possible long term allergen issue in advance. This warning allows preventative advice to be provided to the user.

In addition, during a periodic check of the environment, where the sensing device 100 detects a particular allergen or the amount of the particular allergen is above a certain level, the server 110 can push a warning to the user. The warning may include health advice about how to reduce the impact of the allergen or may include advice describing how to reduce the amount of the allergen in the atmosphere. This warning, therefore, allows the user to take preventative measures to avoid the symptoms associated with the allergen before those symptoms are exhibited.

In the above, the sensing device 100 communicates the spectral signature to the server 110. The server 110 may also communicate the database 420 to the sensing device 100 for storage thereon. The sensing device 100 may then locally access the health advice or perform other functions described herein with respect to the server 110.

Although the above describes the provision of severity of symptoms, the disclosure is not so limited. The health advice provided in the database may not require the severity of symptoms or the symptoms themselves in order to return the health advice to the requesting device (the sensing device 100 or the UE 120). In particular, all that is necessary is that a signature (which define characteristics) of the particle under test is provided. The database 420 (be it located in the server 110 or elsewhere) may then return the health advice associated with the identified particle.

Although the foregoing describes an allergy, the disclosure is not so limited and any kind of advice, warnings or data is envisaged.

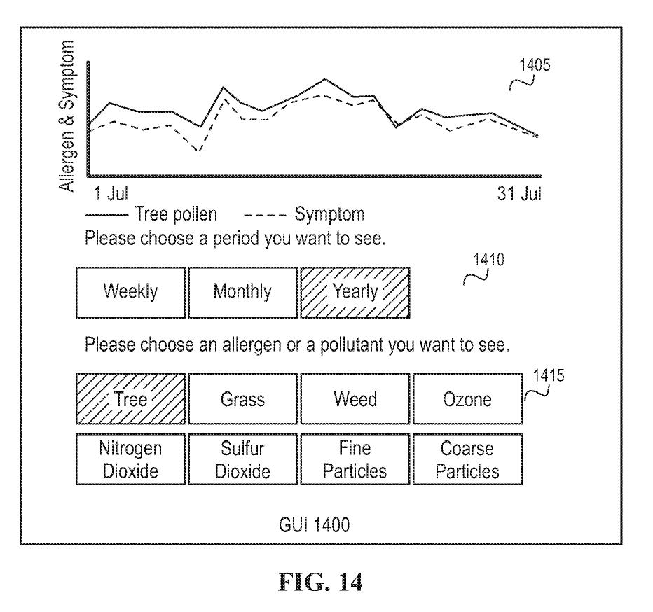

FIG. 14 illustrates a schematic block diagram of an example of another GUI 1400 that may be generated using the health monitoring application 115. In this example, the health monitoring application 115 at the UE 120 and/or server 110 may provide data for and direct a UE 120 to display a graph 1405 including a presence/severity of symptoms and a concentration of a particulate. In this example graph 1405, the density of tree pollen over a period of one month is displayed. The severity or presence of symptoms logged by a selected user of the UE 120 is displayed. The graph 1405 may thus illustrate a correlation between density of a particulate and the presence and/or severity of symptoms of the selected user. The GUI 1400 may include a user selection for input of a time period for display, e.g. such as a weekly graph, a monthly graph or yearly graph. The GUI may also include a user selection for input of one or more allergens or pollutants or other particulates to be displayed in the graph 1405.

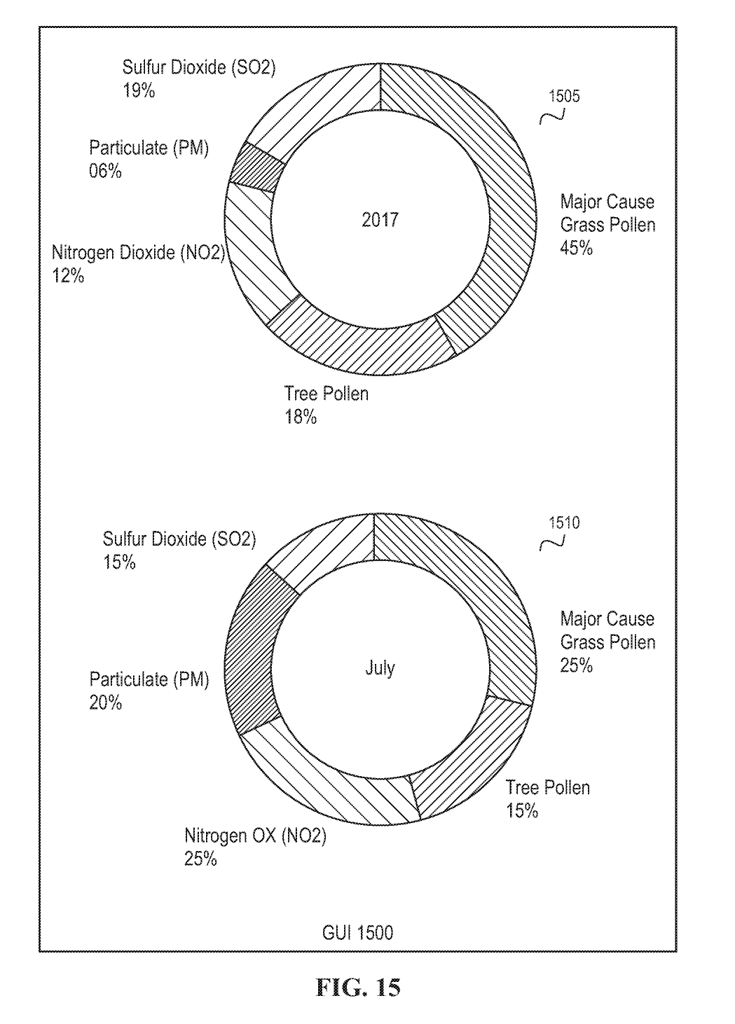

FIG. 15 illustrates a schematic block diagram of an example of another GUI 1500 that may be generated using the health monitoring application 115. The health monitoring application 115 on the UE 120 and/or server 110 correlates logged symptoms and severity of symptoms of a user with identified particulates. For example, the health monitoring application 115 may provide data for and direct a UE 120 to display a graph 1505 including concentration of particulates detected at times that a user logged having symptoms during a year. In the graph 1505, the density of particulates detected during symptomatic conditions during 2017 is displayed. The severity or presence of symptoms of a selected user of the UE 120 is correlated with the density of particulates detected over the year and a percentage of the particulates identified that may be causes of the symptoms over the period.

For example, the graph 1505 shows that a major cause of symptoms during 2017 may be grass pollen at 45% and then sulfur dioxide at 19% and tree pollen at 18%. The graph 1505 shows that a major cause of symptoms during a monthly period of July may be grass pollen at 25% and nitrogen dioxide at 25% and then other particulates at 20%. The health monitoring application 115 may thus determine and display data showing the correlation between various particulates and the presence and/or severity of symptoms logged by a user over a period of time. Again, the GUI 1400 may include a user selection for input of a time period for the display, e.g. such as a daily graph, weekly graph, a monthly graph or yearly graph.

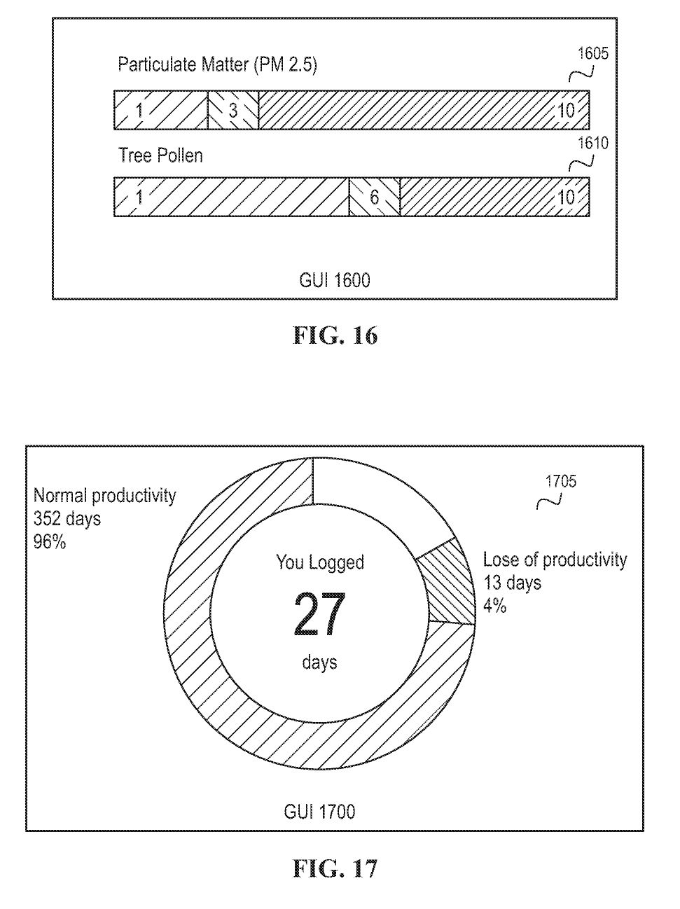

FIG. 16 illustrates a schematic block diagram of an example of another GUI 1600 that may be generated using the health monitoring application 115. The health monitoring application 115 on the UE 120 and/or server 110 correlates logged symptoms and a minimal level of one or more types of particulates present when the symptoms are logged by a user. The symptoms of the user are thus correlated with a minimum concentration of identified particulates in which the logged symptoms were reported. The health monitoring application 115 may then provide data for and direct a UE 120 to display a GUI 1600 including a minimum concentration of a type of particulate detected when a user inputs having symptoms over a requested time period, such as a week, month or year.

For example, the graph 1605 includes a minimum concentration of a type of particulate matter (e.g., 3 PPM) detected when a user inputs having symptoms. The graph 1610 includes a minimum concentration of tree pollen (e.g., 6 PPM) detected when a user inputs or logs having symptoms. The graph 1605 and graph 1610 may thus help predict a minimal level of a particulate that may trigger symptoms in the future.

FIG. 17 illustrates a schematic block diagram of an example of another GUI 1700 that may be generated using the health monitoring application 115. The health monitoring application 115 on the UE 120 and/or server 110 correlates logged symptoms and resulting loss of productivity over a time period. The symptoms of a user are correlated with a typical loss of productivity due to such symptoms. Alternatively or in addition thereto, a user may input loss of productivity due to symptoms. For example, the health monitoring application 115 may provide data for and direct a UE 120 to display a graph 1705 including loss of productivity over a period of time.

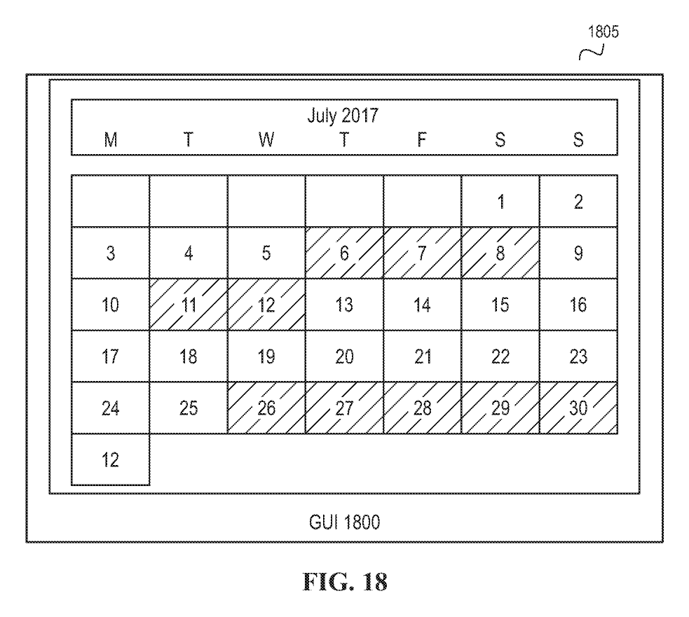

FIG. 18 illustrates a schematic block diagram of an example of another GUI 1800 that may be generated using the health monitoring application 115. The health monitoring application 115 on the UE 120 and/or server 110 stores and tracks a number of times a user logs intaking medication. The health monitoring application 115 may display a calendar 1805 correlated with a typical loss of productivity due to such symptoms. The user may input medication taken due to symptoms. For example, the health monitoring application 115 may provide data for and direct a UE 120 to display a calendar 1805 indicating days in which medication was logged as taken by a user. The calendar 1805 may thus help predict days in a month or year in symptoms are triggered in the future.

The health monitoring application 115 from the UE 120 or server 110 may transmit data to a healthcare provider 195. For example, one or more of the reports or data described herein may be transmitted to a healthcare provider 195. The healthcare provider 195 may provide health advice or medication using such data.

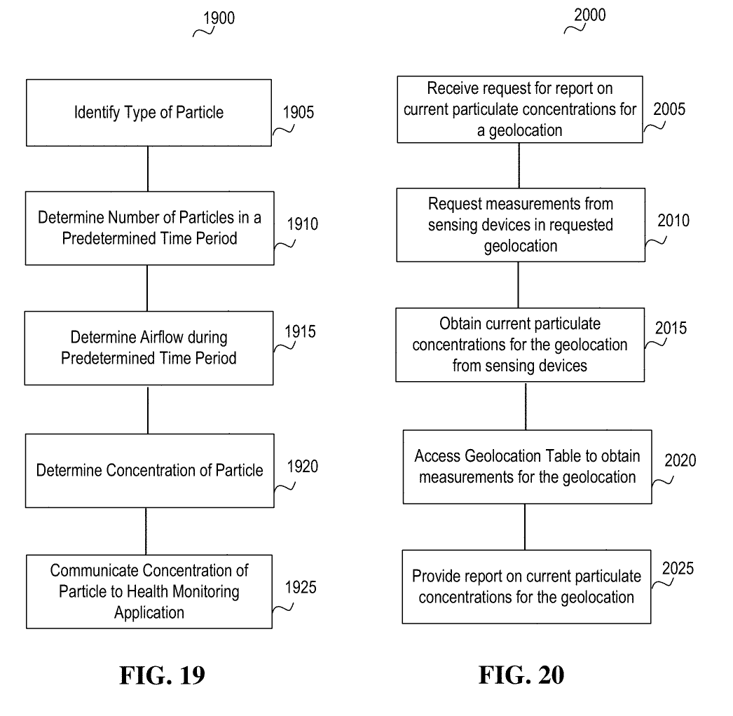

FIG. 19 illustrates a logical flow diagram of an embodiment of a method 1900 for determining a concentration or density of a particle in the air at a geolocation. For example, the concentration of a particle may be provided as a count of how much particulate is in the air. This particulate count represents the concentration of the particulate (e.g., pollen, ragweed, etc.) in the air in a certain geolocation at a specific time. The particulate count may be expressed, e.g., in grains of particulate per cubic meter over a 24 hour period.

First, the sensing device 100 identifies a type of particle, such as pollen, ragweed, etc. at 1905. The sensing device 100 is then configured to determine a number of that type of particle that is identified over a predetermined time period at 1910. For example, the sensing device 100 may take measurements every 10 minutes and provide a count of the number of that type of particle identified over a 24 hour period.

The sensing device 100 also detects airflow at the geolocation during the predetermined time period at 1915. For example, the sensing device 100 determines the speed of the airflow including the type of particle. From this information, the sensing device 100 may obtain a concentration of a particular type of particle for the predetermined time period at 1920.

This information may also be provided to a health monitoring application at the server 110 or UE 120 at 1925. For example, a user may request current particulate counts from an associated sensing device 100 located, e.g., at their home or office. The health monitoring application 115 on a UE 120 transmits a request to the associated sensing device 100. The sensing device 100 then communicates the concentration of identified particles to the UE 120. A user may thus have a current, on demand report of concentration of identified particles, such as allergens, pollutants or other particulates, from an associated sensing device 100 at their home or office.

In another example, the particulate count for a type of particle may also be provided to the server 110 and stored in the geolocation table 920. For example, a concentration of particle types P1 and P2 is recorded for Westminster associated with a first sensing device 100. A density of particles P2 is recorded for Westminster associated with a second sensing device 100. Sensing devices 100 located at other geolocations may also provide concentration of particle types that are recorded in the geolocation table 920. The geolocation table 920 may thus include a concentration of one or more types of particles detected by a sensing device 100 at different geolocations (density of particles P1, P2, P3, etc.) during a time period. This record enables trends for particular locations to be monitored and data collated for users, local authorities or government to monitor allergens, pollutants and other particulates that may have an impact on public health.

FIG. 20 illustrates a logical flow diagram of an embodiment of a method 2000 for providing a current concentration of particles in the air at a geolocation. For example, a user who is traveling to a different city or country may request a current update on concentrations of any potential allergens in the city or country. The user may thus prepare with medications or other remedies for any known allergens. The user inputs the request using the health monitoring application 115 on a UE 120 for a report on current particulate concentrations for a geolocation. The request may be for one type of particle (e.g. pollen, ragweed, or mold) or a general report on the types of particulates identified in the geolocation. The UE 120 transmits the request to the server 110. The server 110 receives the request at 2005 and obtains a current report for the geolocation, e.g. based on readings from one or more sensing devices 100 in the geolocation over the past minutes, hours, or 24 hours. In one embodiment, the server 110 requests current measurements from sensing devices in the requested geolocation at 2010. The sensing devices 100 may perform measurements upon receiving the request and provide the current measurements of particulate concentrations to the server 110 at 2015.

Additionally or alternatively, the server 110 may access the geolocation table 920 to obtain current measurements for the geolocation at 2020. For example, the server 110 may determine from time stamp that measurements have been received from sensing devices in the geolocation within a predetermined time period (e.g. within one minute or one hour). Since the measurements are current within an acceptable predetermined time period, the server 110 may then provide a report based on measurements from the database 420. The server 110 may use a combination of both methods. For example, the server 110 may determine that certain sensing devices 100 in the geolocation have current measurements (e.g. within the hour) but that other sensing devices 100 in the geolocation have not reported current measurements. The server 100 may request current measurements only from these sensing devices 100.

The server 110 thus obtains current measurements from one or more sensing devices 100 in the geolocation. The server 110 may average or mean the measurements from each of the sensing devices 100 to provide a report on current particulate concentrations for the geolocation. The server 110 may provide a range of the particulate concentrations based on the current measurements from one or more sensing devices 100 in the geolocation to the requesting UE 120.

In addition, the server 110 may provide a report on current particulate concentrations for different locations within a same city or country. For example, the server 110 may provide a map illustrating different concentration levels of a particulate outside a building, street, in different regions of a city or a country.

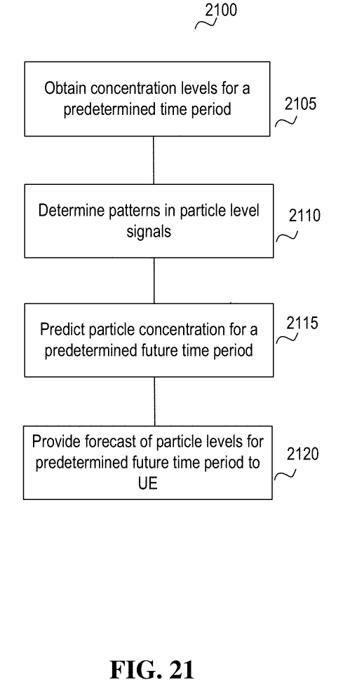

FIG. 21 illustrates a logical flow diagram of an embodiment of a method 2100 for providing a forecast of particle levels in the air at a geolocation. A forecast may be provided for a specific site of a sensing device 100, e.g. inside a dwelling or business or for an outside location of a sensing device 100. In another embodiment, a forecast may be provided for a geolocation over a location of a plurality of sensing devices 100. The forecast may be determined by a sensing device 100 using its sensor outputs or by the server 110 using the sensor outputs of one or more of the plurality of sensing devices 100. The forecast predicts the particle concentration levels for a predetermined future time period. The particle concentration levels may include pollutant levels or allergen levels, such as pollen levels, ozone levels, etc. The future time period may include, e.g., a one day forecast, two day forecast or three day forecast.

To determine the forecast, concentration levels for a predetermined time period are obtained at 2105. For example, the current and past particle concentration levels for one or more days or weeks are obtained. The past concentration levels for the same days or weeks in one or more past years may also be obtained. The concentration levels are graphed versus time, and particle level signals generated for the predetermined time periods.

Patterns in the particle level signals are obtained. For example, trends, noise or periodicity of the particle level signals are determined at 2110. Based on past patterns, particle levels for a predetermined future time period are predicted at 2115. Forecasts for one to three days are generally more accurate than forecasts for longer time periods. An accuracy prediction for the forecast may also be determined.

The forecast of one or more particle levels for the predetermined future time period are provided to users at 2120. The health monitoring application 115 may display the forecasts on GUI of UE 120 upon request or may push automatically for display on UE 120.

Numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

In one or more aspects herein, a processing module or circuit includes at least one processing device, such as a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. A memory is a non-transitory memory device and may be an internal memory or an external memory, and the memory may be a single memory device or a plurality of memory devices. The memory may be a read-only memory, random access memory, volatile memory, non-volatile memory, static memory, dynamic memory, flash memory, cache memory, and/or any non-transitory memory device that stores digital information.

As may be used herein, the term “operable to” or “configurable to” indicates that an element includes one or more of circuits, instructions, modules, data, input(s), output(s), etc., to perform one or more of the described or necessary corresponding functions and may further include inferred coupling to one or more other items to perform the described or necessary corresponding functions. As may also be used herein, the term(s) “coupled”, “coupled to”, “connected to” and/or “connecting” or “interconnecting” includes direct connection or link between nodes/devices and/or indirect connection between nodes/devices via an intervening item (e.g., an item includes, but is not limited to, a component, an element, a circuit, a module, a node, device, network element, etc.). As may further be used herein, inferred connections (i.e., where one element is connected to another element by inference) includes direct and indirect connection between two items in the same manner as “connected to”.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, frequencies, wavelengths, component values, integrated circuit process variations, temperature variations, rise and fall times, and/or thermal noise. Such relativity between items ranges from a difference of a few percent to magnitude differences.

Note that the aspects of the present disclosure may be described herein as a process that is depicted as a schematic, a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The various features of the disclosure described herein can be implemented in different systems and devices without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

In the foregoing specification, certain representative aspects of the invention have been described with reference to specific examples. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims.

Furthermore, certain benefits, other advantages and solutions to problems have been described above with regard to particular embodiments; however, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

Moreover, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is intended to be construed under the provisions of 35 U.S.C. § 112(f) as a “means-plus-function” type element, unless the element is expressly recited using the phrase “means for” or, in the case of a method claim, the element is recited using the phrase “step for.”

1. A sensing device, comprising:
a storage device configured to store a database, wherein the database includes reference spectral signatures for a plurality of types of particles and health advice associated with each of the plurality of types of particles;
a sensor configured to obtain a spectral signature of at least one particle in an airflow; and
sensor control circuitry configured to:
compare the spectral signature of the at least one particle in the airflow with the reference spectral signatures for the plurality of types of particles;
identify a first type of particle corresponding to the at least one particle in the airflow; and
access the database to obtain health advice associated with the identified first type of particle.

2. The sensing device of claim 1, further comprising communication circuitry configured to:
communicate over a network to a remote server; and
receive from the remote server the reference spectral signatures for the plurality of types of particles and the health advice associated with each of the plurality of types of particles.

3. The sensing device of claim 2, wherein the sensor control circuitry is further configured to:
store in the database the identified first type of particle and location information identifying a geographical location of the sensing device; and
communicate the identified first type of particle and location information identifying a geographical location of the sensing device to the remote server.

4. The sensing device of claim 1, wherein the sensor control circuitry is configured to compare the spectral signature of the at least one particle in the airflow with the reference spectral signatures for the plurality of types of particles by:
determining local maxima and minima points in the spectral signature of the at least one particle in the airflow; and
comparing the local maxima and minima points in the spectral signature of the at least one particle in the airflow with local maxima and minima points in the reference spectral signatures for the plurality of types of particles.

5. The sensing device of claim 1, wherein the sensor control circuitry is further configured to:
receive logged symptoms of a user; and
access the database to obtain health advice associated with the identified first type of particle and the logged symptoms of the user.

6. The sensing device of claim 5, wherein the sensor control circuitry is further configured to:
receive a logged severity of symptoms by a user; and
access the database to obtain health advice associated with the identified first type of particle, the logged symptoms of the user and the logged severity of symptoms by the user.

7. The sensing device of claim 1, wherein the sensor control circuitry is further configured to:
communicate the health advice associated with the identified first type of particle to a user device.

8. The sensing device of claim 1, wherein the sensor control circuitry is further configured to:
receive the logged symptoms of the user and the logged severity of symptoms by the user from the user device.

9. The sensing device of claim 1, wherein the identified first type of particle includes at least one of: an allergen, pollutant or other type of airborne particulate.

10. A method for monitoring airborne particles, comprising:
obtaining a spectral signature of at least one particle in an airflow;
comparing the spectral signature of the at least one particle in the airflow with reference spectral signatures for a plurality of types of particles;
identifying a first type of particle corresponding to the at least one particle in the airflow from the comparison;
accessing a database to obtain health advice associated with the identified first type of particle; and
providing the health advice to a user device for display.

11. The method of claim 10, wherein comparing the spectral signature of the at least one particle in the airflow with the reference spectral signatures for the plurality of types of particles comprises:
determining local maxima and minima points in the spectral signature of the at least one particle in the airflow; and
comparing the local maxima and minima points in the spectral signature of the at least one particle in the airflow with local maxima and minima points in the reference spectral signatures for the plurality of types of particles.

12. The method of claim 10, further comprising:
receiving logged symptoms from the user device; and
accessing the database to obtain health advice associated with the identified first type of particle and the logged symptoms of the user.

13. The method of claim 12, further comprising:
receiving a logged severity of symptoms from the user device; and
accessing the database to obtain health advice associated with the identified first type of particle, the logged symptoms of the user and the logged severity of symptoms by the user.

14. The method of claim 13, wherein the identified first type of particle includes at least one of: an allergen, pollutant or other type of airborne particulate.

15. The method of claim 14, further comprising:
determining a number of the first type of particle in the air flow during a predetermined time period;
determining an air flow speed during the predetermined time period; and
obtain a concentration of the first type of particle during the predetermined time period.

16. The method of claim 15, further comprising:
determining the logged severity of symptoms by the user over a requested time period and a concentration of at least the first type of particle over the requested time period.

17. The method of claim 16, further comprising:
generating a report for display on the user device, wherein the report includes the concentration of the first type of particle over the requested time period and the logged severity of symptoms by the user over the requested time period.

18. The method of claim 15, further comprising:
determining the logged symptoms by the user over a requested time period and a minimum concentration of at least the first type of particle in which the logged symptoms were reported over the requested time period.

19. The method of claim 18, further comprising:
generating a report for display on the user device, wherein the report includes the minimum concentration of at least the first type of particle in which the logged symptoms were reported over the requested time period.

20. The method of claim 15, further comprising:
determining the logged severity of symptoms by the user over a requested time period and loss of productivity over the requested time period; and
generating a report for display on the user device, wherein the report includes the loss of productivity over the requested time period.

21. The method of claim 10, further comprising:
obtain past particle level signals for a predetermined time period;
determine signal patterns in the past particle level signals; and
predict a particle concentration for a predetermined future time period using the signal patterns in the past particle level signals.
